(19) United States
(12) Patent Application Publication
(10) Pub. No.: US 2026/0064522 A1
(43) Pub. Date: Mar. 5, 2026

(54) Machine Learning Based Reconciliation Error Detection And Correction

(71) Applicant: Oracle International Corporation, Redwood Shores, CA (US)

(72) Inventors: John D. Clark, JR., Pepperell, MA (US); Pathanjali Malay, Leawood, KS (US); Tim Gaumont, Mesa, AZ (US)

(73) Assignee: Oracle International Corporation, Redwood Shores, CA (US)

(21) Appl. No.: 19/095,583

(22) Filed: Mar. 31, 2025

Related U.S. Application Data
(60) Provisional application No. 63/690,646, filed on Sep. 4, 2024.

(51) Int. Cl. G06F 11/07

(52) U.S. Cl. CPC G06F 11/0793

(57) ABSTRACT

Techniques for applying a generative artificial intelligence (AI) model to identify and correct anomalies in remediation records are disclosed. A system trains and applies a generative AI model to displayed datasets to predict remediation record anomalies. If the system detects the generation of a remediation record in a dataset to reconcile the displayed datasets, the system generates a generative AI prompt that includes the remediation record. The generative AI model generates an output that identifies anomalies in the remediation record and the datasets being reconciled. The generative AI model further generates recommendations for remediating errors in the remediation record.

### BENEFIT CLAIMS; RELATED APPLICATIONS; INCORPORATION BY REFERENCE

This application claims the benefit of U.S. Provisional Patent Application 63/690,646, filed Sep. 4, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to machine learning based reconciliation of datasets. In particular, the present disclosure relates to applying a generative artificial intelligence (AI) model to datasets to identify and remediate anomalies in remediation records for reconciling the datasets.

### BACKGROUND

With vast amounts of data stored in different locations and maintained by different entities, organizations are incapable of manually identifying every discrepancy among different sets of records that record the same sets of events. For example, an organization may rely on one external entity to maintain records of events associated with one type of event. The organization may rely on another entity to maintain records of events of another type. The organization may maintain its own records of the different types of events.

When attempting to verify datasets and/or determine a current state of data, goods, and/or currency recorded in different datasets, organizations may identify various types of discrepancies. One dataset may include an event record that another dataset omits. Two datasets may include records for the same event, but they may be recorded with different attribute values, such as a time of the event, a category of the event, or a magnitude associated with the event. Errors may arise from user entry of data or from miscalculations in an automated application. Different sources of datasets may vary in reliability. Accordingly, a discrepancy between a primary dataset and a secondary dataset may be treated differently from a discrepancy between the primary dataset and a tertiary dataset.

Organizations need to identify an accurate state of data stored in datasets to generate forecasts and allocate resources based on the data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A-1D illustrate a system in accordance with one or more embodiments;

FIGS. 2A-2C illustrate an example set of operations for correcting remediation record errors in accordance with one or more embodiments;

FIGS. 3A-3D illustrate an example embodiment; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DATASET RECONCILIATION ARCHITECTURE
3. CORRECTING REMEDIATION RECORD ERRORS BASED ON GENERATIVE AI PREDICTIONS
4. EXAMPLE EMBODIMENT
5. COMPUTER NETWORKS AND CLOUD NETWORKS
6. HARDWARE OVERVIEW
7. MISCELLANEOUS; EXTENSIONS

### 1. GENERAL OVERVIEW

Dataset reconciliation is a process where at least one attribute value for one dataset is matched to the corresponding attribute value(s) in another dataset. If a discrepancy exists between the datasets, a user or system may insert a remediation record into at least one of the datasets. A remediation record is a record that explains and/or acknowledges the discrepancy. Insertion of the remediation record may result in updating the attribute value within at least of the datasets such that the corresponding attribute values match across the datasets. Alternatively, or additionally, the remediation record may be stored in association with an update that causes the corresponding attribute values to match across the datasets. The remediation record may include a description or code representing a reason for the discrepancy. For example, an inventory management system may generate a remediation record in a central warehouse's inventory log to reflect a delay between when a shipment is sent from the central warehouse and when the shipment is received by a storefront. The remediation record may describe the quantity of goods shipped and a remediation record category, such as “in transit. ” As another example, a data management system may generate a remediation record to reflect data files that were transmitted from a central server but were not received by a client server. The remediation record may describe an amount of data associated with the discrepancy, such as “10 Gb” and a remediation record category, such as “Transmission interrupted. ” According to yet another example, a financial management system may generate a remediation record to describe a user error entering a value for a financial transaction. The remediation record may describe an amount involved, such as “$14” and a remediation record category, such as “Transposition error. ”

As an example, an inventory management system may include a log of the transfer of goods from a central warehouse to a storefront. The storefront may maintain a log file of goods received from the central warehouse. The central warehouse's log file may record 10 transfers of goods totaling 100 units. The storefront log file may record 9 transfers of goods from the central warehouse, totaling 90 units. A remediation record may include an attribute value, such as “10units” and a classification, such as “in transit. ” The remediation record does not change the number of units the central warehouse has shipped or the storefront has received. Instead, it reconciles the attributes of the respective logs by providing a reason for the discrepancy between the logs.

One or more embodiments train and apply a generative artificial intelligence (AI) model to identify and remediate anomalies in remediation records for reconciling datasets. A system monitors a graphical user interface (GUI) to detect the creation of a remediation record for remediating discrepancies among two or more datasets. The system generates a prompt for the generative AI model that predicts anomalies in the remediation record. The prompt includes the remediation record and contextual data from one or more displayed datasets. The generative AI model further generates a recommendation for remediating the anomaly. For example, the generative AI model may generate an alternative remediation record to replace the original remediation record.

One or more embodiments display an error message, or a warning message, based on the generative AI detecting an anomaly associated with a remediation record. The system monitors an application for user actions taken in response to displaying the error message. For example, the system may present a recommended action together with a predicted error. The user may modify the remediation record based on the recommended action. In another instance, a user may notify the system that the predicted anomaly is incorrect and should not be applied to the remediation record. The system may receive the user feedback to retrain the generative AI model to refrain from subsequently predicting the same error for the same set of data. Additionally, or alternatively, the system may generate prompt data that includes the anomaly and the remediation record. The system may include the prompt data in subsequent generative AI prompts as a negative example to prevent the generative AI model from generating the same anomaly message based on the same conditions in the future.

One or more embodiments described in this Specification and/or recited in the claims may not be included in this General Overview section.

### 2. DATASET RECONCILIATION ARCHITECTURE

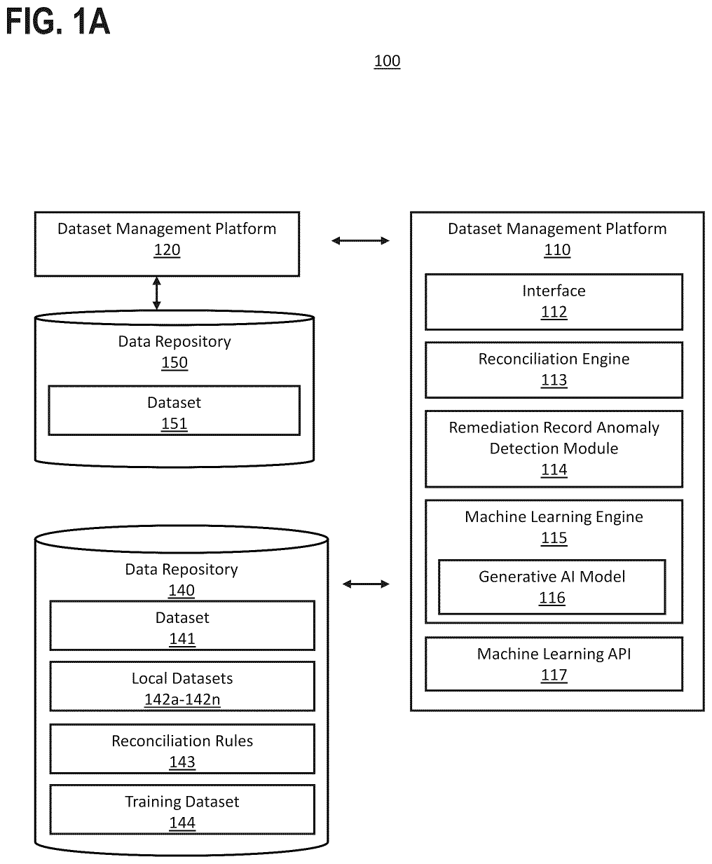

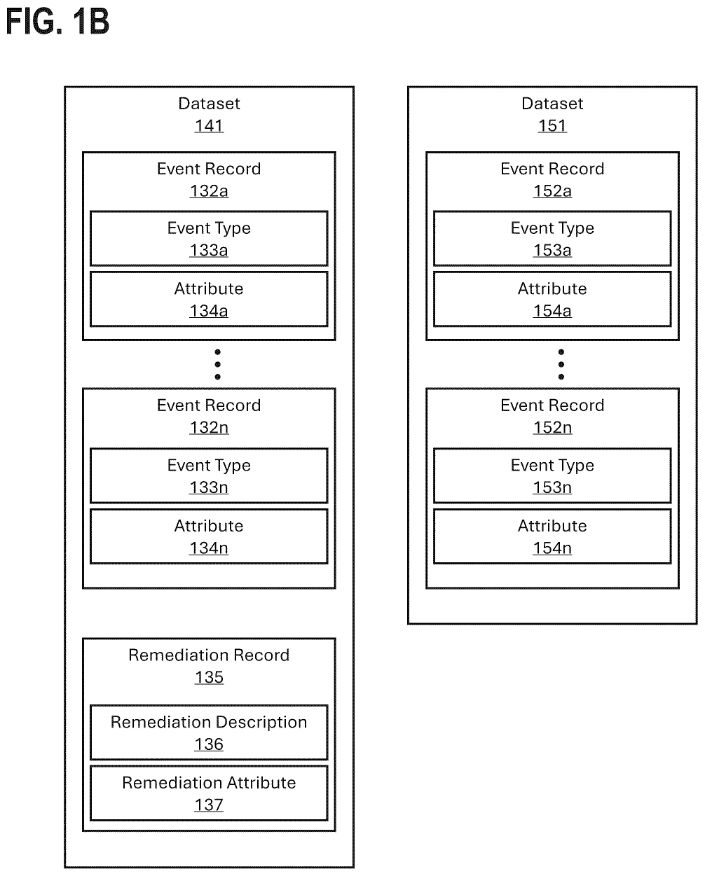

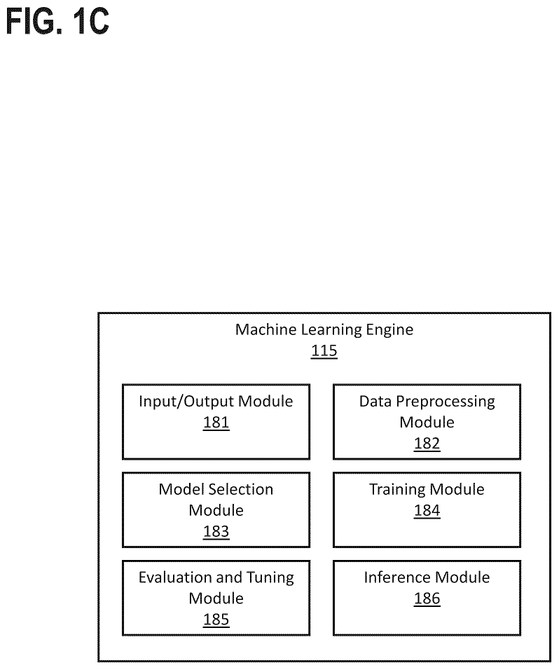

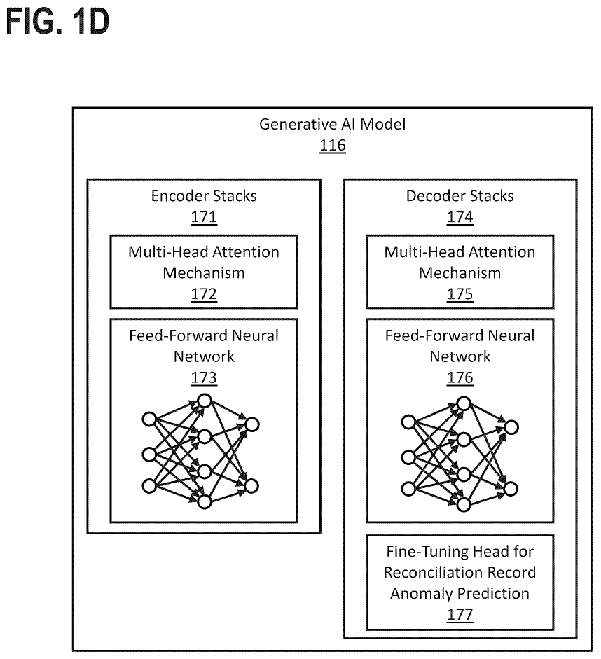

FIGS. 1A-1D illustrate a system 100 in accordance with one or more embodiments. As illustrated in FIG. 1A, system 100 includes dataset management platforms 110 and 120 and data repositories 140 and 150. The dataset management platforms 110 and 120 manage access to respective datasets 141 and 151.

In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks. ”In one or more embodiments, a data repository 140 is any type of storage unit and/or device (e.g., a file system, database, collection of tables, or any other storage mechanism) for storing data. Furthermore, a data repository 140 may include multiple different storage units and/or devices. The multiple different storage units and/or devices may or may not be of the same type or located at the same physical site. Furthermore, a data repository 140 may be implemented or executed on the same computing system as the dataset management platform 110. Additionally, or alternatively, a data repository 140 may be implemented or executed on a computing system separate from the dataset management platform 110. The data repository 140 may be communicatively coupled to the dataset management platform 110 via a direct connection or via a network.

Information describing datasets 141 and 142a-142n, reconciliation rules 143, and training dataset 144 may be implemented across any components within the system 100. However, this information is illustrated within the data repository 140 for purposes of clarity and explanation.

The dataset management platform 110 includes an interface 112. The interface 112 allows a user to interact with the dataset management platform 110 to view datasets, perform reconciliations, and manage the automated performance of auto-reconciliations.

In one or more embodiments, interface 112 refers to hardware and/or software configured to facilitate communications between a user and the dataset management platform 110. Interface 112 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 112 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 112 is specified in one or more other languages, such as Java, C, or C++.

The dataset management platform 110 manages local datasets 141 and 142a-142n in the data repository 140. The dataset management platform 120 manages the remote dataset 151 in the data repository 150. The dataset management platforms 110 and 120 may be implemented as applications running on computers, such as servers, to receive requests to access and modify data stored in datasets. Dataset management platform 110 may download the remote dataset 151 at defined intervals from the dataset management platform 120 to add to the local datasets 142a-142n.

Datasets 141, 142a-142n, and 151 may comprise event records. The event records may record the transfer of goods, currency, and/or data between entities. Datasets may correspond to defined periods of time. For example, dataset 141 may specify events that were recorded in one month. Dataset 142a may specify events that were recorded in another month. Datasets includes lists of events stored as event records. An event record may be stored as an entry in a table. For example, a dataset may include data arranged in rows and columns. One row may specify a date. Another row may specify an event type. Another row may specify an attribute associated with the event, such as a magnitude of a transaction, transfer, or transmission. The rows may represent events, and the columns may specify the date, type, and magnitude associated with the event. The row in the above example may be referred to as an event record.

According to one example, the dataset management platform 110 is associated with a company. The dataset management platform 120 is associated with a financial institution. In this example, the dataset 141 may represent a general ledger recording transactions between the company and other entities, including the financial institution. The dataset 151 represents transactions between the financial institutions and the company. According to another example, the event records represent the transfer of goods between locations. In this example, the dataset management platform 110 may be associated with a central warehouse, and the dataset management platform 120 may be associated with a manufacturing center or with a retail location. The dataset 141 represents the transfer of goods between the central warehouse and other entities, including manufacturing centers, retail locations, and other warehouses. The dataset 151 represents the transfer of goods from the manufacturing center to the central warehouse.

According to yet another example, dataset management platform 110 is associated with a data storage center such as central server in a cloud computing environment. Dataset management platform 120 represents a client server. In this example, dataset 141 represents the transfer to data objects, applications, and/or update packages from the central server to remote servers, including the client servers. Dataset 151 represents a record of transfers of data objects from the central server to the client server represented by dataset management platform 120.

The dataset management platform 110 includes a reconciliation engine 113. The reconciliation engine 113 identifies discrepancies among datasets (e.g., datasets 141 and 151 and 142a-142n) and generates remediation records to remediate discrepancies and to reconcile the datasets. In some embodiments, users interact with the interface 112 to generate the remediation records in the datasets. Remediating discrepancies may be performed automatically, without human intervention, or manually, by a human. Examples of discrepancies between datasets include the following: different cumulative values for an attribute across sets of event records; a different attribute value for two event records that correspond to the same event in two datasets; incorrect record identifiers, such as names or categories; incorrect dates associated with an event in event records; records that appear in different reconciliation periods in datasets maintained by different entities; and records that appear in one dataset and are absent from another dataset but which should be present in both datasets (or absent from both datasets).

The reconciliation engine 113 generates a remediation record to add to a dataset to reconcile the dataset to another dataset. The remediation record includes at least one attribute.

The reconciliation engine 113 assigns a value to the attribute to result in reconciliation of datasets. The system assigns a name, ID, or category to the remediation record to describe the discrepancy. For example, the cumulative value of an attribute across the event records in one dataset may be 100. The cumulative value of the attribute across the event records in another dataset may be 97. The reconciliation engine 113 may generate a remediation record with an attribute value of 3. The reconciliation engine 113 may add the remediation record to the latter dataset to bring the cumulative value of the attribute to 100. The reconciliation engine 113 may further assign a name to the remediation record of “mis-entered record” or “record included in next reporting period. ” Alternatively, the reconciliation engine 113 may generate a remediation record with an attribute value of −3. The reconciliation engine 113 may add the remediation record to the former dataset to bring the cumulative value for the attribute to 97.

In one or more embodiments, a dataset includes a set of event records that correspond to events recorded in a system. For example, a set of event records may record a series of shipments from a warehouse to external locations. A remediation record may be a record that remediates a discrepancy by, for example, providing an explanation and/or an acknowledgement of the discrepancy. A remediation record may include a description of an attribute value associated with a discrepancy between two datasets or between two sets of event records. A remediation record may further include a reason for the discrepancy. In the example of a shipment log, a remediation record may include a value, “10 units,” and a reason why a discrepancy of 10 units exists between two shipment records, such as “lost in transit,” “delayed delivery,” or “delivered to wrong destination. ”

FIG. 1B illustrates an example of datasets 141 and 151 and a remediation record 135. Dataset 141 includes a set of event records 132a-132n. The event records 132a-132n specify an event type 133a-133n and an attribute 134a-134n. Dataset 151 includes event records 152a-152n. Event records 152a-152n specify an event type 153a-153n and an attribute 154a-154n. In an example, the reconciliation engine 113 may determine that the cumulative value of attributes 134a-134n is 100 and the cumulative value of attributes 154a-154n is 80. The reconciliation engine 113 may further determine that the cumulative values should match. Accordingly, the reconciliation engine 113 generates a remediation record 135. The remediation record 135 includes a remediation description 136 and a remediation attribute 137. The remediation description 136 may be, for example, a category describing a reason for the discrepancy between the cumulative values of the attributes 134a-134n and 154a-154n. The remediation attribute 137 may be assigned a value of-20. The value for the remediation attribute 137 is selected to reconcile the cumulative attribute value 134a-134n with the cumulative attribute value 154a-154n. The reconciliation engine 113 adds the remediation record 135 to the dataset 141 to reconcile the datasets 141 and 151.

While an example is illustrated in FIG. 1B of one dataset 141 being reconciled to one dataset 151, in some embodiments one dataset 141 may be reconciled to multiple different datasets. For example, a central warehouse may ship goods to multiple different storefronts. A dataset maintained by the central warehouse may be reconciled to multiple different datasets maintained by the multiple different storefronts. In addition, while the example illustrated in FIG. 1B illustrates a single remediation record 135, in some embodiments reconciling two or more datasets involves adding multiple remediation records to a dataset. For example, a discrepancy of 20 units may be the result of three different discrepancies, such as a transposition error, a delay in delivery, and a missing event record. Accordingly, the reconciliation engine 113 may generate three different remediation records to add to the dataset 141 to reconcile the datasets 141 and 151.

The reconciliation engine 113 reconciles datasets based on reconciliation rules 143. Rules include conditions for when to manually reconcile datasets, when to auto-reconcile datasets, and how to generate a remediation record. Conditions may be based on attributes of event records, attribute values, dates associated with event records, entities associated with event records (such as individuals, organizations, or companies), a time associated with the event record, and patterns associated with an attribute over multiple defined periods of time.

A remediation record anomaly detection module 114 monitors data presented in a graphical user interface (GUI) of the interface 112 to identify remediation records. For example, a user may generate a remediation record in a dataset. Alternatively, the reconciliation engine 113 may apply a set of reconciliation rules 143 to generate a remediation record automatically without human intervention. According to yet another alternative example, the system may apply machine learning to generate a remediation record. Based on detecting the remediation record in the dataset displayed in the GUI, the remediation record anomaly detection module 114 analyzes the remediation record to identify one or more anomalies and/or errors in the remediation record. Reconciliation errors may include anomalies that result in violating one or more reconciliation rules 143 or other reconciliation requirements. For example, an enterprise may require data A, data B, and data C to be included in a remediation record. The remediation record anomaly detection module 114 may detect an error in a remediation record that includes data A and data B but omits data C. A set of reconciliation rules 143 may require a particular classification for a certain type of remediation record. The remediation record anomaly detection module 114 may detect an error when a remediation record includes an incorrect classification. According to another example, a set of reconciliation rules 143 may require a manually generated remediation record when a discrepancy between two datasets exceeds a threshold amount. The remediation record anomaly detection module 114 may detect an error when a reconciliation engine 113 generates a remediation record automatically without human intervention.

The remediation record anomaly detection module 114 may identify some anomalies that may not qualify as errors. In other words, anomalies may be categorized by severity. Some anomalies may correspond to issues to be aware of. Other anomalies may require remediation to avoid discrepancies and inconsistencies among datasets. For example, the remediation record anomaly detection module 114 may identify a remediation record as an anomaly where it includes correct information, but it is the third consecutive time-series dataset requiring a remediation record. As another example, an entity associated with a remediation record may be identified as a dormant entity that has not been cited in an event record for a predefined period of time. The remediation record anomaly detection module 114 may identify the entity as an anomaly.

A machine learning engine 115 trains a generative AI model 116 to identify anomalies in remediation records and in datasets including remediation records. In one or more embodiments, the machine learning engine employs a machine learning algorithm to train the generative AI model 116. The machine learning algorithm is an algorithm that can be iterated to train a target model f that best maps a set of input variables to an output variable, using a set of training data, including the training dataset 144. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm, which in turn updates the target model f.

FIG. 1C illustrates an example of a machine learning engine 115. As illustrated in FIG. 1C, machine learning engine 115 includes input/output module 181, data preprocessing module 182, model selection module 183, training module 184, evaluation and tuning module 185, and inference module 186.

In accordance with an embodiment, input/output module 181 serves as the primary interface for data entering and exiting the system, managing the flow and integrity of data. This module may accommodate a wide range of data sources and formats to facilitate integration and communication within the machine learning architecture.

In an embodiment, an input handler within input/output module 181 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 181 to be versatile in different operational contexts, whether processing historical datasets or streaming data.

In accordance with an embodiment, input/output module 181 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 181 includes an output framework designed to handle the distribution and exportation of outputs, predictions, or insights. Using the output framework, input/output module 181 formats these outputs into user-friendly and accessible formats, such as reports, visualizations, or data files compatible with other systems. Input/output module 181 also ensures secure and efficient transmission of these outputs to end-users or other systems in an embodiment and may employ encryption and secure data transfer protocols to maintain data confidentiality.

In accordance with an embodiment, data preprocessing module 182 transforms data into a format suitable for use by other modules in machine learning engine 115. For example, data preprocessing module 182 may transform raw data into a normalized or standardized format suitable for training ML models and for processing new data inputs for inference. In an embodiment, data preprocessing module 182 acts as a bridge between the raw data sources and the analytical capabilities of machine learning engine 115.

In an embodiment, data preprocessing module 182 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 182 may be configured to handle anomalies in different ways depending on context. Data preprocessing module 182 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 182 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 182 processes new data for inference, data preprocessing module 182 replicates the same preprocessing steps to ensure consistency with the training data format. This helps to avoid discrepancies between the training data format and the inference data format, thereby reducing the likelihood of inaccurate or invalid model predictions.

In an embodiment, model selection module 183 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 183 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 183 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 183 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 183 also considers computational efficiency and resource constraints. This is meant to help ensure the selected model is both accurate and practical in terms of computational and time requirements. In an embodiment, certain features of model selection module 183 are configurable such as a configured bias toward (or against) computational efficiency.

In accordance with an embodiment, training module 184 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 184 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 184 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 184 includes logic to handle different types of data and learning tasks. For instance, it includes different training routines for supervised learning (where the training data comes with labels) and unsupervised learning (without labeled data). In the case of deep learning models, training module 184 also manages the complexities of training neural networks that include initializing network weights, choosing activation functions, and setting up neural network layers.

In an embodiment, evaluation and tuning module 185 incorporates dynamic feedback mechanisms and facilitates continuous model evolution to help ensure the system's relevance and accuracy as the data landscape changes. Evaluation and tuning module 185 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 185 performs continuous model tuning by using hyperparameter optimization. Evaluation and tuning module 185 performs an exploration of the hyperparameter space using algorithms, such as grid search, random search, or more sophisticated methods like Bayesian optimization. Evaluation and tuning module 185 uses these algorithms to iteratively adjust and refine the model's hyperparameters - settings that govern the model's learning process but are not directly learned from the data - to enhance the model's performance. This tuning process helps to balance the model's complexity with its ability to generalize and attempts to avoid the pitfalls of underfitting or overfitting.

In an embodiment, evaluation and tuning module 185 integrates data feedback and updates the model. Evaluation and tuning module 185 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 185 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 185 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 186 transforms data raw data into actionable, precise, and contextually relevant predictions. In addition to processing and applying a trained model to new data, inference module 186 may also include post-processing logic that refines the raw outputs of the model into meaningful insights.

In an embodiment, inference module 186 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 186 transforms the outputs of a trained model into definitive classifications. Inference module 186 employs the underlying model as a tool to generate probabilistic outputs for each potential class. It then engages in an interpretative process to convert these probabilities into concrete class labels.

In an embodiment, when inference module 186 receives the probabilistic outputs from the model, it analyzes these probabilities to determine how they are distributed across some or every potential class. If the highest probability is not significantly greater than the others, inference module 186 may determine that there is ambiguity or interpret this as a lack of confidence displayed by the model.

In an embodiment, inference module 186 uses thresholding techniques for applications where making a definitive decision based on the highest probability might not suffice due to the critical nature of the decision. In such cases, inference module 186 assesses if the highest probability surpasses a certain confidence threshold that is predetermined based on the specific requirements of the application. If the probabilities do not meet this threshold, inference module 186 may flag the result as uncertain or defer the decision to a human expert.

Inference module 186 dynamically adjusts the decision thresholds based on the sensitivity and specificity requirements of the application, subject to calibration for balancing the trade-offs between false positives and false negatives.

In accordance with an embodiment, inference module 186 contextualizes the probability distribution against the backdrop of the specific application. This involves a comparative analysis, especially in instances where multiple classes have similar probability scores, to deduce the most plausible classification. In an embodiment, inference module 186 may incorporate additional decision-making rules or contextual information to guide this analysis, ensuring that the classification aligns with the practical and contextual nuances of the application.

In regression models, where the outputs are continuous values, inference module 186 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 186 incorporates domain-specific adjustments into its post-processing routine. This involves tailoring the model's output to align with specific industry knowledge or contextual information. For example, in financial forecasting, inference module 186 may adjust predictions based on current market trends, economic indicators, or recent significant events, ensuring that the outputs are both statistically accurate and practically relevant.

In an embodiment, inference module 186 includes logic to handle uncertainty and ambiguity in the model's predictions. In cases where inference module 186 outputs a measure of uncertainty, such as in Bayesian inference models, inference module 186 interprets these uncertainty measures by converting probabilistic distributions or confidence intervals into a format that can be easily understood and acted upon. This provides users with both a prediction and an insight into the confidence level of that prediction. In an embodiment, inference module 186 includes mechanisms for involving human oversight or integrating the instance into a feedback loop for subsequent analysis and model refinement.

In an embodiment, inference module 186 formats the final predictions for end-user consumption. Predictions are converted into visualizations, user-friendly reports, or interactive interfaces. In some systems, like recommendation engines, inference module 186 also integrates feedback mechanisms, where user responses to the predictions are used to continually refine and improve the model, creating a dynamic, self-improving system.

Referring to FIG. 1A, in an embodiment, machine learning engine API 117 allows for applications to leverage machine learning engine 115. In an embodiment, machine learning engine API 117 may be built on a RESTful architecture and offer stateless interactions over standard HTTP/HTTPS protocols. Machine learning engine API 117 may feature a variety of endpoints, each tailored to a specific function within machine learning engine 115. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 117 is equipped to support SOAP-based interactions. This extension involves defining a WSDL (Web Services Description Language) document that outlines the API's operations and the structure of request and response messages. In an embodiment, machine learning engine API 117 supports various data formats and communication styles. In an embodiment, machine learning engine API 117 endpoints may handle requests in JSON format or any other suitable format. For example, machine learning engine API 117 may process XML, and it may also be engineered to handle more compact and efficient data formats, such as Protocol Buffers or Avro, for use in bandwidth-limited scenarios.

In an embodiment, machine learning engine API 117 is designed to integrate WebSocket technology for applications necessitating real-time data processing and immediate feedback. This integration enables a continuous, bi-directional communication channel for a dynamic and interactive data exchange between the application and machine learning engine 115.

The machine learning engine 115 trains the generative AI model 116 to identify anomalies in remediation records added to datasets. The generative AI model 116 may also be trained to identify anomalies in datasets that include remediation records. The generative AI model 116 may generate additional content, including recommendations for correcting anomalies and citations to reconciliation rules associated with the anomalies.

A generative model is a machine learning model that is capable of generating new data instances based on the data used to train the model. In the present specification, a generative model may be referred to as a “generative artificial intelligence (AI) model. ” Generative models learn the underlying distribution of the training data, enabling them to produce new instances of data that share properties with the original dataset. This capability makes them particularly useful in a variety of applications, including image and voice generation, text synthesis, and more sophisticated tasks, like unsupervised learning, semi-supervised learning, and domain adaptation.

One type of generative model is a large language model (LLM). Large language models (LLMs) are designed to understand, generate, and interpret human language by processing extensive collections of data. The foundational architecture behind LLMs is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times. In one embodiment, the generative AI model 116 is an LLM.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head, self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 181 (described in FIG. 1C), when used for LLMs, handles textual data, converting input text into a format that the model can process. This typically involves tokenization, where the text is broken down into manageable pieces, such as words or sub-words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 182 (described in FIG. 1C) in the context of LLMs may include steps, such as normalization, where the text is converted to a uniform case and punctuation is standardized. This process ensures that the model treats similar words or symbols consistently, reducing the complexity of the input space. Additionally, techniques, such as sentence segmentation, may be applied to manage longer texts, enabling the model to process information in chunks that align with natural language structures.

In accordance with one or more embodiments, model selection module 183 (described in FIG. 1C), when used for LLMs, involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 184 (described in FIG. 1C), when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as Graphics Processing Units (GPUs) or Tensor Processing Units (TPUs), to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 185 assesses the performance of LLMs using various metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation.

Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 186, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

As illustrated in FIG. 1D, in an embodiment, the generative AI model 116 is a transformer-type machine learning model. The generative AI model 116 includes a set of encoder stacks 171 and a set of decoder stacks 174. Each encoder stack in the set of encoder stacks 171 includes a multi-attention head mechanism 172 and a feed-forward neural network 173. Each decoder stack in the set of decoder stacks 174 includes a multi-attention head mechanism 175, a feed-forward neural network 176, and a fine-tuning head 177 for generating remediation record anomaly predictions. In one embodiment, the generative AI model 116 is a fine-tuned LLM. While the fine-tuning head 177 is illustrated in FIG. 1D as being added to an output for the decoder stacks 174, in one or more embodiments, the fine-tuning head 177 is added to an output of the encoder stacks 171. The decoder stacks 174 may receive the output from the encoder stacks 171 and the fine-tuning head 177 to generate a human-understandable output.

The encoders in the set of encoder stacks 171 include multi-attention heads 172 that provide a self-attention mechanism. Likewise, decoders in the set of decoder stacks 174 include multi-head attention mechanisms 175. The attention mechanism dynamically determines weights for elements of input tokens of an input vector based on input queries and element keys. The result of the attention mechanism is a combined representation of an input sequence. The generative AI model 116 generates the combined representation by concatenating the outputs from multiple attention heads, where each attention head focuses on different aspects of the input sequence. The generative AI model 116 then applies a linear transformation to the concatenated output. The multi-attention head 172 allows the encoder 171 to simultaneously focus on different aspects of an input sequence by running multiple independent attention mechanisms (i.e., “heads”) in parallel. Focusing on different aspects of the set of input elements allows the encoder 171 to encode embeddings representing input data with additional data representing relationships between elements within the set of input data elements.

The feed-forward neural network 173 converts the output from the multi-head attention mechanism 172 into a set of output sequences that include a word vector embedding sequence and a positional encoder sequence. The word vector embeddings are numerical representations of text. The positional encoding sequence represents the relative positions of words in the word vector embedding sequence. Each sub-layer of the encoder stacks 171 receives an output from the previous sub-layer and applies the attention mechanism 172 and neural network 173 to the output from the previous sub-layer to generate a new output embedding representing the input sequence. Likewise, each sub-layer of the decoder stacks 174 receives an output from the previous sub-layer and applies the attention mechanism 175 and neural network 176 to the output from the previous sub-layer to generate a new output embedding representing the input sequence. Unlike the encoder stacks 171, the final layer of the decoder stacks 174 outputs a sequence of words instead of an embedding representing the input sequence.

The generative AI model 116 includes a fine-tuning head for remediation record anomaly prediction and error correction. In one embodiment, one or more final layers of the final decoder stack among the decoder stacks 174 is removed. A new set of neural layers is added to the final, feed-forward neural network 176. The generative AI model 116 is then re-trained on a dataset including (a) historical datasets, (b) historical discrepancies associated with pairs of the historical datasets, (c) historical remediation records added to the historical datasets to remediate the historical discrepancies, and (d) historical anomalies associated with the historical remediation records. However, in retraining the model, each neural layer of each neural network 173 and 176, other than the fine-tuning head 177, is frozen. In other words, the model maintains constant the parameters (e.g., offsets and weights) of the neurons in the neural networks 173 and 176 other than the parameters of the neurons in the fine-tuning head 177. In another embodiment, the fine-tuning head 177 is appended to the final layer of the final, feed-forward neural network 176 without removing any layers from the final, feed-forward neural network 176. In yet another embodiment, one or more final layers of the final encoder stack, among the encoder stacks 171, is removed. A new set of neural layers (i.e., the fine-tuning head 177) is added to the final, feed-forward neural network 173. The generative AI model 116 is then re-trained on the dataset described above.

The generative AI model 116 generates remediation record anomaly predictions and error correction recommendations based on receiving input data including (a) dataset attributes, such as attributes specifying a number, type, and values for event records, and discrepancy data specifying discrepancies between datasets and (b) remediation record data specifying attributes of a remediation record added to a dataset in a pair of reconciled datasets.

The training dataset 144 includes training records that implement reconciliation rules 143. The training dataset includes historical datasets, historical discrepancies associated with pairs of the historical datasets, historical remediation records added to the historical datasets to remediate the historical discrepancies, and historical anomalies associated with the historical remediation records. In some embodiments, the training dataset 144 further includes historical corrections to remedial records to address anomalies.

In operation, the dataset management platform 110 may download dataset 151 from a remote system to store it among the datasets 142a-142n managed by the dataset management platform 110. For example, in an inventory management system, the dataset management platform 110 may regularly download inventory data from remote locations. The dataset management platform 110 may store the datasets downloaded from remote locations separately from datasets that record inventory transactions internally.

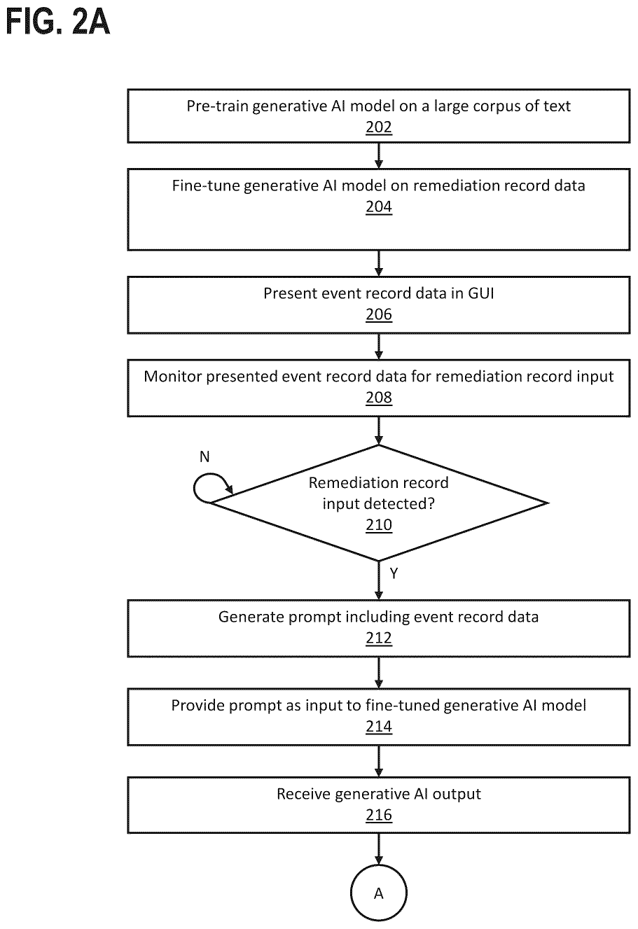

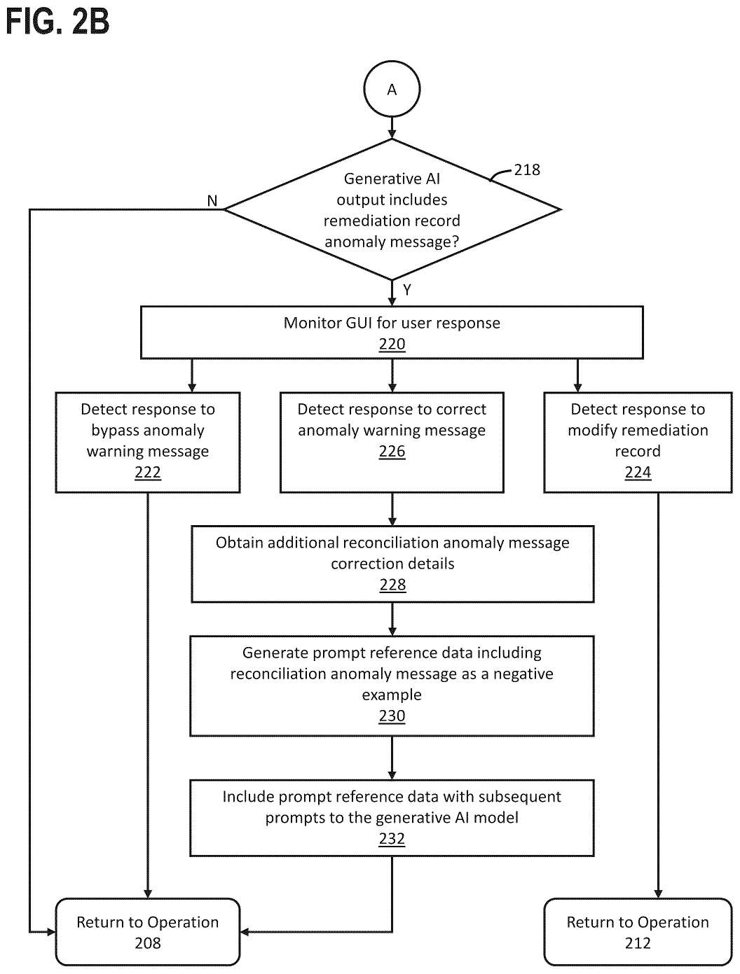

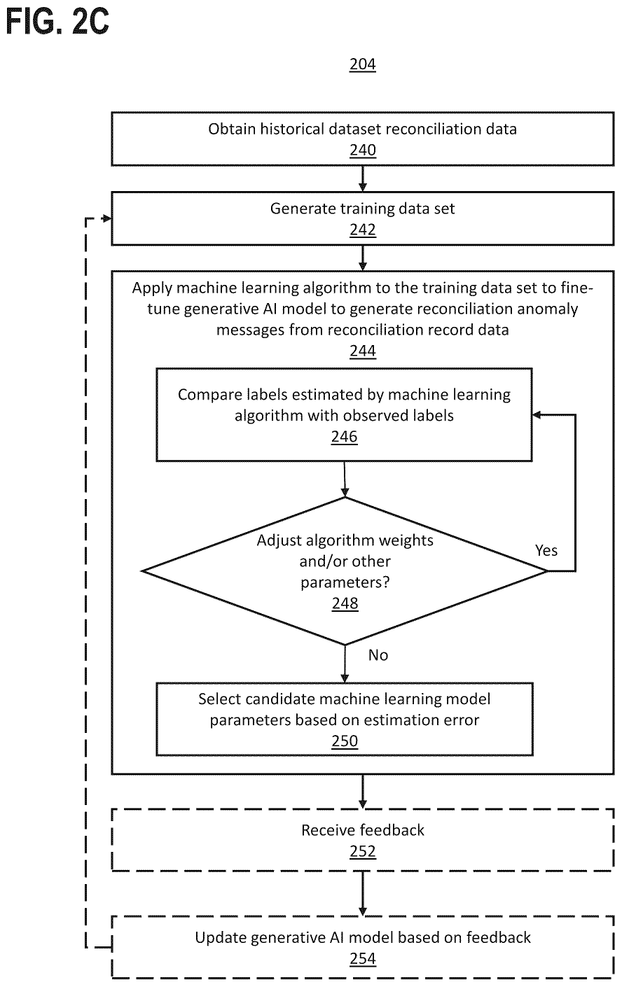

In one or more embodiments, a dataset management platform 110 refers to hardware and/or software configured to perform operations described herein for ensuring the validity of datasets by reconciling datasets generated from different entities with each other. Examples of operations for reconciling datasets based on machine learning recommendations are described below with reference to FIGS. 2A-2C.

In an embodiment, the dataset management platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a server, and a mainframe.

### 3. CORRECTING REMEDIATION RECORD ERRORS BASED ON GENERATIVE AI PREDICTIONS

FIGS. 2A-2C illustrate an example set of operations for remediating generative AI-detected anomalies in remediation records in accordance with one or more embodiments. One or more operations illustrated in FIGS. 2A-2C may be modified, rearranged, or omitted. Accordingly, the particular sequence of operations illustrated in FIGS. 2A-2C should not be construed as limiting the scope of one or more embodiments.

FIGS. 2A-2C illustrate an example set of operations for modifying datasets to correct reconciliation anomalies predicted by a generative AI machine learning model in accordance with one or more embodiments. One or more operations illustrated in FIGS. 2A-2C may be modified, rearranged, or omitted. Accordingly, the sequence of operations illustrated in FIGS. 2A-2C should not be construed as limiting the scope of one or more embodiments.

Referring to FIG. 2A, a system pre-trains a generative AI model on a large corpus of text (Operation 202). In one embodiment, the system obtains a pre-trained AI model. The pre-trained AI model is trained on a dataset that includes a broad vocabulary to learn relationships among words and grammatical rules. The pre-trained AI model is trained to receive a sequence of tokens that represent words and sub-words as input data and to generate an embedding representing the sequence as output data. The embedding is a multi-dimensional numerical vector.

In an alternative embodiment, the machine learning model includes an encoder and a decoder. For example, the machine learning model may be a transformer-type model. The decoder generates a sequence of words based on the encoded embeddings generated by the encoder.

The system fine-tunes the generative AI model on dataset reconciliation data (Operation 204). Dataset reconciliation data includes historical datasets, historical discrepancies associated with pairs of the historical datasets, historical remediation records added to the historical datasets to remediate the historical discrepancies, and historical anomalies associated with the historical remediation records. In some embodiments, dataset reconciliation data further includes historical corrections to remedial record errors and/or anomalies.

In an embodiment, fine-tuning the generative AI model includes adding a fine-tuning head to the pre-trained model by attaching an additional neural network layer to the output of the pre-trained machine learning model. Adding the fine-tuning head results in generating a different type of output data from the pre-trained model. While the pre-trained model is configured to receive sequences of tokens as input data and generate embeddings for the sequences as output data, the fine-tuning head is configured to receive the embeddings from the pre-trained machine learning model as input data and to predict remediation record anomalies for dataset reconciliation data. For example, different output nodes of the fine-tuning head may correspond to different reconciliation errors.

To train the fine-tuning head on the dataset reconciliation data, the system freezes the parameters of the pre-trained machine learning model. The offsets and coefficients of the pre-trained machine learning model are set at their pre-trained values to prevent the parameters from changing in subsequent training of the fine-tuned machine learning model, including the fine-tuning head.

The pre-trained model and the fine-tuning head together make up a generative AI model. The system trains the generative AI model with datasets, including remediation records, errors, and anomalies, to generate predicted remediation record anomalies for sets of event records. During training of the generative AI model, the parameters of the pre-trained machine learning model remain frozen while the system modifies the parameters of the neurons that make up the fine-tuning head. In this manner, the system improves the functioning of the generative AI model in the technological field of dataset reconciliation.

Example operations for fine-tuning the generative AI model are described in FIG. 2C. In an embodiment, a system obtains historical dataset reconciliation data (Operation 240). Obtaining the historical dataset reconciliation data may include obtaining historical event records that reflect reconciliations between a set of event records managed by an entity and one or more additional sets of event records. The additional sets of event records may include, for example, additional accounts (e.g., reconciling a sub-ledger with a general ledger) and sets of event records (e.g., invoices, receipts, payment outflow records, payment inflow records). According to one or more embodiments, obtaining the historical reconciliation data includes obtaining descriptions of transaction data and/or account data that is not presented in an account record.

For example, the historical account reconciliation data may include metadata, such as transaction type, customer type, customer name, account holder name or identifier (ID), and types of goods and/or services associated with a transaction. The historical account reconciliation data further includes anomaly warning messages generated based on the historical reconciliations. Examples of reconciliation errors include remediation records with incorrect debits, incorrect credits, duplicate charges, transposition errors, misclassifications, incorrect dates, payments applied to an incorrect invoice, unauthorized transactions, and currency conversion errors.

According to another embodiment, obtaining the historical dataset reconciliation data may include obtaining historical data transmission records reflecting dataset reconciliations between a set of data transmission records of one set of data stored in memory (such as in a database) and one or more additional sets data stored in memory. The additional sets of data transmission records may include, for example, additional tables (e.g., reconciling a subset of data, such as data stored in a client device, with a central repository, such as a central database) and sets of data transmission records (e.g., data transmission requests, data transmission confirmations, data transmission logs). According to one or more embodiments, obtaining the historical dataset reconciliation data includes obtaining descriptions of transmission data that is not presented in a stored dataset. For example, the historical dataset reconciliation data may include metadata, such as transmission type, customer type, customer name, client name or identifier (ID), and types of data associated with a data transmission (such as video, voice, data objects, images, text files, etc.). The historical dataset reconciliation data further includes anomaly warning messages generated based on the historical reconciliations. Examples of reconciliation errors include remediation records with incorrect attribute values, duplicate remediation records, transposition errors, misclassifications, incorrect dates, data transmission directed to incorrect locations, and unauthorized data transmissions.

The system uses the historical reconciliation data to generate a set of training data (Operation 242). The set of training data includes, for a particular set of dataset reconciliation data, including a plurality of event records and a remediation record, at least one classification label. For example, a set of reconciliation data may include a first set of event records of a first type and a second set of event records of a second type. The first set of event records may be records that are reconciled to the second set of event records by a remediation record that has been added to the first set of event records. For example, in a financial environment, the second set of financial records may correspond to financial institution records. A company's general ledger may be reconciled to the financial institution records by adding a remediation record to the general ledger. The remediation record includes an attribute value selected to reconcile the first set of event records to the second set of event records. The training data further includes an error associated with the remediation record. For example, the error may indicate that the remediation record is of an incorrect type, has an incorrect value, or is mapped to the incorrect event record in the second set of event records. Additionally, or alternatively, the error may indicate that the remediation record fails to reconcile the datasets. A value included in the remediation record may be inadequate to reconcile values of the datasets.

According to one embodiment, the system obtains the historical data and the training data set from a data repository storing labeled data sets. The training data set may be generated and updated by an event record management system. In an example embodiment in which the event records are financial transactions, the system may be a financial record management system. Alternatively, the training data set may be generated and maintained by a third party. According to one embodiment, the system generates the labeled set of data by parsing documents and generating labels based on parsed values in the documents. According to an alternative embodiment, one or more users generate labels for a data set.

In some embodiments, generating the training data set includes generating a set of feature vectors for the labeled examples. A feature vector, for an example, may be n-dimensional, where n represents the number of features in the vector. The number of features that are selected may vary. The features may be curated in a supervised approach or automatically selected from extracted attributes during model training and/or tuning. Example features include event record type, attribute amount, account type, customer type, owner type, customer or owner identifier (ID), the event record date for events in a set of event records, and the event record data representing a date when a set of event records was captured (such as a date of dataset reconciliation). In some embodiments, a feature within a feature vector is represented numerically by one or more bits. The system may convert categorical attributes to numerical representations using an encoding scheme, such as one-hot encoding, label encoding, and binary encoding. One-hot encoding creates a unique binary feature for each possible category in an original feature. In one-hot encoding, when one feature has a value of 1, the remaining features have a value of 0. For example, if a type of transaction service has ten different categories, the system may generate ten different features of an input data set. When one category is present (e.g., value “1”), the remaining features are assigned a value “0.” According to another example, the system may perform label encoding by assigning a unique numerical value to each category. According to yet another example, the system performs binary encoding by converting numerical values to binary digits and creating a new feature for each digit.

The system applies a machine learning algorithm to the training data set to train the machine learning model (Operation 244). Training the machine learning model may include freezing a pre-trained transformer type model and training a fine-tuning head added to the pre-trained model. In one example, a machine learning algorithm may analyze the training data set to train neurons of a neural network with weights and offsets. The weights and offsets associate sets of reconciled event records with reconciliation error labels. As discussed above, the reconciliation error labels indicate predicted error messages associated with reconciliations.

The system iteratively applies the machine learning algorithm to sets of event record data in a set of input data to generate an output set of labels, compares the generated labels to pre-generated labels associated with the input data, adjusts weights and offsets of the algorithm based on an error value, and applies the algorithm to another set of event record data.

In some embodiments, the system compares the labels estimated through the one or more iterations of the machine learning model algorithm with observed labels to determine an estimation error (Operation 246). The system may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the system determines whether or not to adjust the weights and/or other model parameters based on the estimation error (Operation 248). Adjustments may be made until the system identifies a candidate model that minimizes the estimation error or otherwise achieves a threshold level of estimation error. The process may return to Operation 246 to adjust and continue training the machine learning model.

In some embodiments, the system selects machine learning model parameters based on the estimation error meeting a threshold accuracy level (Operation 250). For example, the system may select a set of parameter values for a machine learning model based on determining that the trained model has an accuracy level for predicting labels for remediation records of at least 98%.

In some embodiments, the system trains a neural network using backpropagation without applying the backpropagation to the pre-trained machine learning model.

Backpropagation is a process of updating cell states in the neural network based on gradients determined as a function of the estimation error. With backpropagation, nodes are assigned a fraction of the estimated error based on the contribution to the output and adjusted based on the fraction. In recurrent neural networks, time is also factored into the backpropagation process. As previously mentioned, a given example may include a sequence of sets of event records. Each set of event records may be processed as a separate discrete instance of time. For instance, an example may include set of event records r₁, r₂, and r₃ corresponding to times t, t+1, and t+2, respectively. Backpropagation through time may perform adjustments through gradient descent starting at time t+2 and moving backward in time to t+1 and then to t. Furthermore, the backpropagation process may adjust the memory parameters of a cell such that a cell remembers contributions from previous sets of event records in the sequence of sets of event records. For example, a cell computing a contribution for r₃ may have a memory of the contribution of r₂, which has a memory of r₁. The memory may serve as a feedback connection such that the output of a cell at one time (e.g., t) is used as an input to the next time in the sequence (e.g., t+1). The gradient descent techniques may account for these feedback connections such that the contribution of one set of event records to a cell's output may affect the contribution of the next set of event records in the cell's output. Thus, the contribution of r₁ may affect the contribution of r₂, etc.

Additionally, or alternatively, the system may train other types of machine learning models. For example, the system may adjust the boundaries of a hyperplane in a support vector machine or node weights within a decision tree model to minimize estimation error. Once trained, the machine learning model may be used to predict remediation record anomaly labels for new examples of sets of event records.

In embodiments in which the machine learning algorithm is a supervised machine learning algorithm, the system may optionally receive feedback on the various aspects of the analysis described above (Operation 252). For example, the feedback may affirm or revise remediation record anomaly labels generated by the machine learning model. The machine learning model may indicate that a particular set of event records that include a particular remediation record is associated with a label indicating the remediation record includes an error. The system may receive feedback indicating that the remediation record does not include the error. Based on the feedback, the machine learning training set may be updated, thereby improving its analytical accuracy (Operation 254). As another example, the machine learning model may indicate that a particular set of event records is associated with a label indicating a remediation record includes an anomaly of a first type. The system may receive feedback indicating that the remediation record includes an anomaly of a different type. The machine learning training set may be updated based on the feedback. According to yet another example, the machine learning model may indicate that a particular set of event records is associated with a label recommending a particular remediation path to correct an error in a remediation record. The system may receive feedback indicating that a different remediation path should be recommended. The machine learning training set may be updated based on the feedback.

Once updated, the system may further train the machine learning model by optionally applying the model to additional training data sets.

Returning to FIG. 2A, the system presents a set of event record data in a GUI (Operation 206). The GUI may present a first set of event records to be reconciled to a second set of event records. Event records to be reconciled may include accounts made up of transactions or event records. Additional records against which the accounts are reconciled may include additional accounts, purchase records, invoices, bank statements, and other financial documents. In some embodiments, event record datasets describe different events, such as the transfer of goods, services, or money. In some embodiments, events include electronic transfers of data, objects, and files. An event record dataset includes a set of records. The records store attribute values for record attributes. Examples of attributes include a date and/or time that an event occurred and a magnitude associated with an event. In an embodiment where an event record is a transaction record, the record may include an amount of money and/or a quantity of goods or services transferred. Event records may include additional attributes, such as an event ID and a type of event. Event record datasets may be stored digitally as tables in computer memory or databases.

As an example, a system may present a GUI to a user to manage transaction data. A user may select a primary account to be reconciled with a secondary account or set of records. The system may present a set of transactions associated with the primary account to be reconciled. A user may select one or more additional sets of transaction data to reconcile the account. The additional sets of transaction data may include additional accounts or other financial records, such as bank records, invoices, and credit statements. A user may select a primary account and a secondary account. In an embodiment where the event records are financial records, the user may select a company account record and a bank statement. The user may reconcile the company account record to the bank statement. Additionally, or alternatively, a user may select a set of invoices to reconcile with a set of inventory data for a set of goods. Records may include the transfer of goods between locations without reference to any exchange of money. For example, an inventory management platform may store records for warehouses. The set of event records may record the transfer of items between warehouses. In yet another embodiment, the event records represent the transfer of data among nodes in a system, such as between a host database and client databases, or among servers in a system. The system may reconcile data that has been requested by clients with data that is stored in client devices.

The system monitors the user interface to detect a remediation record input (Operation 208). For example, the system may detect the generation of a remediation record in an account that has characteristics associated with reconciling one account to one or more additional sets of transaction data. Monitoring includes detecting a type of user input or a computer-generated remediation record. For example, transactions may be assigned different labels to denote categories for credits and debits in an account. A remediation record remediates discrepancies between datasets to reconcile the datasets. Remediation records are stored among a set of event records even though remediation records are not records describing a particular transaction or event. Accordingly, monitoring the GUI may include determining if a user selects a reconciliation label for an event. According to another example, monitoring includes detecting keystrokes. A system may compare alphanumerical content entered by a user to stored content associated with remediation records. A system may detect a discrepancy value between two accounts. The system may identify a record as a remediation record based on detecting the user entered an attribute value that matches the discrepancy value.

The system determines if an input has been detected that corresponds to adding a remediation record to a set of event records (Operation 210). For example, the system may detect that a record entered by a user is classified as a remediation record. Additionally, or alternatively, the system may determine that the record entered by the user has a value and/or description that corresponds to a remediation record. According to one example, detecting a remediation record input includes detecting a pattern of two or more event records with defined characteristics.

In one or more embodiments, determining if a remediation record input is detected includes detecting a computer-generated remediation record. For example, an event record platform may apply a set of rules to generate remediation records to reconcile datasets. The platform may apply the rules without intervening user input to generate the remediation record.

Based on detecting a remediation record input, the system generates a prompt to provide to the generative AI model (Operation 212). The prompt includes the event record data. The event record data includes a remediation record. The event record data may further include additional event data, such as attributes of other event records in a dataset, data corresponding to a type, number, and magnitude of discrepancies among datasets over time, sets of rules applied to generate remediation records, and sets of rules applied to determine whether remediation records include errors or anomalies. In one embodiment, the prompt includes a set of instructions to the generative AI model directing the generative AI model to predict reconciliation error codes associated with the remediation record. The prompt may include a digital file representing the remediation record.

In one embodiment, a system applies a first set of rules to generate a remediation record to reconcile datasets and a second set of rules to identify errors and/or anomalies in remediation records. For example, the first set of rules may specify conditions for generating remediation records and data to be included in the remediation records. The second set of rules may specify conditions associated with different specifications associated with different sets of requirements. For example, one specification associated with a first entity may specify a first set of rules for maintaining data integrity among datasets. Another specification associated with a second entity may specify a second set of rules for maintaining data integrity among datasets.

Generating the prompt may include attaching different sets of rules to the prompt to cause the generative AI model to analyze remediation records for different types of anomalies corresponding to different entities and different specifications. Alternatively, the different sets of rules may be embodied in training datasets used to train the fine-tuning head described previously in connection with FIG. 2C.

The system provides the prompt to the fine-tuned generative AI model (Operation 214). The generative AI model (a) tokenizes the event record data that includes the remediation record and (b) runs the tokenized event record data through the generative AI model.

As discussed above, tokenizing the event record data includes converting words, phrases, or groups of numbers into tokens. A token is a set of one or more characters that are grouped together. For example, a token may be a word separated from adjacent tokens by spaces. In addition, a number (e.g., “30”) is a separate token. The system may identify tokens within the event record data using a tokenizer. The tokenizer determines if a character is a part of a token associated with an adjacent, previously analyzed character, or if the character is part of a separate token. The tokenizer may consider attributes of the characters to determine if two adjacent characters belong to the same token. In addition, the system may analyze additional attributes of the text to identify semantic meaning of the text (such as emphasis) and a relatedness of tokens to each other. For example, the system may analyze the following: a font of the characters, an amount of spacing or distance between characters, spacing associated with the font, a formatting style of the characters, a language of the characters, and a character type (e.g., alphanumeric or punctuation) of the characters. In an embodiment in which the generative AI model includes an encoder-type model and a fine-tuning head, the generative AI model converts the tokenized event record data, including the reconciliation input, into an embedding. The generative AI model inputs the embedding into the fine-tuning head to generate an output value corresponding to a remediation record anomaly.

In one embodiment, the generative AI model is a transformer-type model that includes an encoder and a decoder. The encoder encodes the tokenized event record data, including the reconciliation input, into an embedding. The encoder may provide the embedding to the fine-turning head to generate an embedding corresponding to a remediation record anomaly. The generative AI model inputs the embedding from the fine-tuning head into the decoder to generate a human-understandable description of a remediation record anomaly. The decoder may generate the remediation record description as a string of text content. In one or more embodiments, the decoder further outputs a recommendation for correcting or remediating the remediation record error or anomaly.

The system receives an output from the generative AI model (Operation 216). The output includes a message describing a remediation record anomaly that the generative AI model predicts is associated with the remediation record. The output may include multiple error messages or classifications. In some embodiments, the output specifies a record/anomaly pair.

For example, a set of event record data may include multiple remediation records. The generative AI model may predict separate errors for separate remediation records.

In one or more embodiments, the message generated by the generative AI model includes an error or anomaly associated with a dataset that includes the remediation record. For example, the generative AI model may predict that the attribute values of the remediation record are inadequate to reconcile two datasets. Additionally, or alternatively, the message generated by the generative AI model may include a recommendation for remediating errors or anomalies associated with the remediation record. For example, the message may include a selectable interface element to generate a new remediation record to add to a dataset or to modify an existing remediation record to alter one or more values of the remediation record.

Referring to FIG. 2B, the system determines if the generative AI output includes a remediation record anomaly message (Operation 218). In some cases, the generative AI may predict no errors or anomalies for a given set of event record data and remediation records. In other cases, the generative AI may predict one or more errors or anomalies for a single set of event record data. If the generative AI output includes an anomaly prediction, the system presents the anomaly prediction in the GUI. For example, as a user generates a new remediation record in a set of event records displayed in the GUI, the system may display a window specifying a predicted error associated with the remediation record.

According to one example, the system may present a window in the GUI that indicates a warning about a remediation record. The window may include text, such as “This remediation record may result in a reconciliation error. The reasons include...”. The system may identify features of the remediation record that may contribute to the error message, such as an incorrect categorization of the record, a date that does not align with other event records in a dataset, or a transposition of a value in the remediation record.

In an example embodiment, the remediation record is a remediation record added to a dataset of financial transaction records. The generative AI output may include a message including an error code associated with a reconciliation error. Some examples include: DUPLICATE_TRANSACTION, MISSING_TRANSACTION, AMOUNT_MISMATCH, DATE_MISMATCH, UNMATCHED_ENTRY, BANK_FEE_ERROR, and PENDING_DEPOSIT_ERROR.

Based on determining the generative AI output specifies at least one predicted anomaly associated with a remediation record, the system monitors the application and/or device presenting the GUI for a user response (Operation 220). Monitoring the application and/or device may include, for example, determining if a user selects a presented window or other interface element in the GUI or detecting keystrokes entered by a user. For example, when the system presents the message in the GUI specifying a predicted anomaly, the system may present a set of interface elements, such as “Edit Record,” “Disregard Message,” “Disregard One-Time,” and “Feedback. ”A user may select one of the interface elements to initiate an associated workflow.

In some cases, the system may detect a response to bypass the anomaly warning message (Operation 222). For example, a user may continue to interact with the GUI to create or modify one or more additional event records without modifying the remediation record that was the subject of the warning message. Additionally, or alternatively, a user may interact with an interface element in the warding message window to close the window. If the system detects a response to bypass or ignore the anomaly warning message, the system returns to Operation 208 to detect additional reconciliation inputs.

In some cases, the system may detect a response to modify the remediation record or other event records to address the predicted anomaly described in the anomaly warning message (Operation 224). For example, a user may edit remediation record attributes by modifying a category, a numerical value, and/or a description of the remediation record. The system may determine that the modification corresponds to the reason for the reconciliation error. If the system detects the response to modify the event record data based on the predicted anomaly warning message, the system returns to Operation 212 to generate and apply a prompt to the generative AI model and to determine if the modification results in additional predicted errors, fewer predicted errors, or alternative predicted errors. If the modifications resolve the predicted errors (e.g., if the generative AI model predicts no reconciliation errors), the system may modify the GUI to remove error messages.

According to one example, the system presents an interface element with the anomaly warning message that corresponds to a recommended action for resolving the error predicted by the generative AI model. For example, if the error message indicates the generative AI model predicts a remediation record would elicit an error for being miscategorized, the system may present an interface element that, when selected, would change the category of the remediation record.

In some cases, the system may detect a response to correct the anomaly warning message (Operation 226). For example, the system may present an interface element together with the anomaly warning message. The interface element may be labeled to provide feedback to the system that the predicted anomaly warning message is incorrect. For example, a user may determine that the anomaly warning message has been incorrectly applied to the remediation record. A user may determine a different anomaly or error that would apply or that no error or anomaly would apply. Accordingly, the user may interact with the interface element to correct the anomaly prediction by the generative AI model.

Based on detecting a response to correct the anomaly warning message generated by the generative AI model, the system extracts additional anomaly warning message correction details (Operation 228). For example, the system may extract data from the remediation record, such as the transaction amount, categorization, and description. The system may extract metadata such as the identity of a user entering the remediation record.

According to one example, if the system detects a user input indicating the predicted anomaly warning is incorrect, the system may provide one or more interface elements to request additional details from a user. A user may input underlying features in a remediation record that make the remediation record correct. For example, a generative AI model may generate an anomaly warning message indicating a record's date does not match a reference record, and the record's amount does not match the amount in the reference record. A user may indicate the predicted error is incorrect because the remediation record is one of multiple remediation records associated with a single reference record. As another example, the user may indicate that the remediation record category is correct, where the generative AI predicted an error message based on an incorrect categorization. Accordingly, the system may automatically obtain a first set of data in an automated process and/or receive user input specifying a second set of data.

In response to receiving feedback to correct the anomaly warning message, the system may generate a set of prompt reference data to include with subsequent prompts to the generative AI model (Operation 230). The prompt reference data may include the anomaly warning message and remediation record context data. The prompt may identify the anomaly warning message as a negative example that the generative AI model should not generate when the generative AI model encounters the remediation record context data. For example, the system may generate a set of prompt reference data that (a) specifies an anomaly warning message predicted by the generative AI model and (b) specifies contextual remediation record data and/or reasons why the anomaly warning message prediction was incorrect. The contextual remediation record data may include characteristics of the remediation record and additional event record data. The prompt may direct the generative AI model to refrain from generating a predicted error message when certain conditions are present. For example, the generative AI model may predict a particular error message for a given set of transaction data that includes reconciliation data. The prompt may direct the generative AI to not present the predicted error message when two or more remediation records with a particular classification add up to a reconciliation value.

The system stores the prompt reference data to include in subsequent prompts to the generative AI model (Operation 232). When the generative AI model detects the conditions specified in the prompt reference data, the generative AI model refrains from generating the corresponding predicted reconciliation error. In other words, the generative AI model may be trained to predict an anomaly based on a particular set of remediation record data. However, the generative AI model will refrain from generating an anomaly warning message for the anomaly based on the previously received feedback and the negative example included in the generative AI prompt.

While an example is provided above where the system generates prompt reference data to direct the generative AI model to refrain from generating anomaly warning messages when certain conditions are detected in a set of transaction data, in additional and/or alternative embodiments, the system retrains the generative AI model based on the feedback to the anomaly warning messages. In the example embodiment in which the generative AI model includes an encoder and fine-tuning head, the system may create a training data record or set of training data records that specify a set of event record conditions and a label to not predict a remediation record error based on the conditions. The system retrains the fine-tuning head based on the set of training data records.

While an example is provided above, where the generative AI model generates a message and receives user input to take actions based on the message, one or more embodiments configure a system to implement a generative AI recommendation without intervening user input. For example, upon detecting an error in a remediation record, a generative AI model may (a) generate a replacement remediation record, (b) replace the initial remediation record with the replacement, and (c) generate a message asking a user to confirm a modification. For example, the message may include content, such as the following: “Value changes to match event record 123. Keep changes?” A user may then confirm or reject the generative AI-implemented modifications to the remediation record.

### 4. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

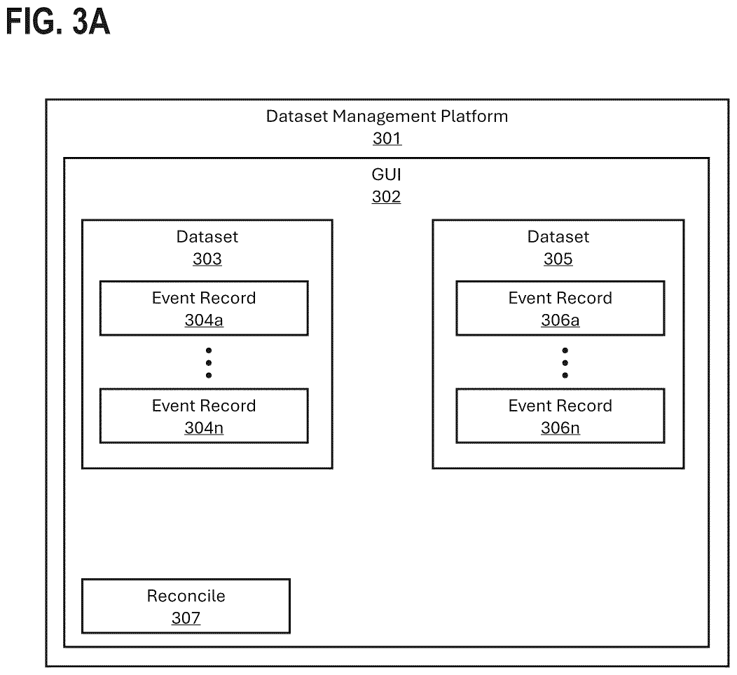

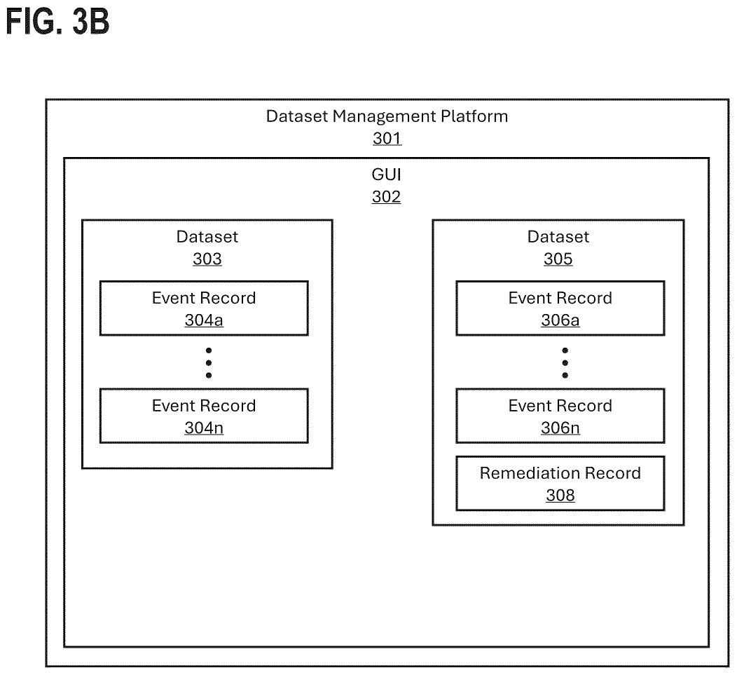

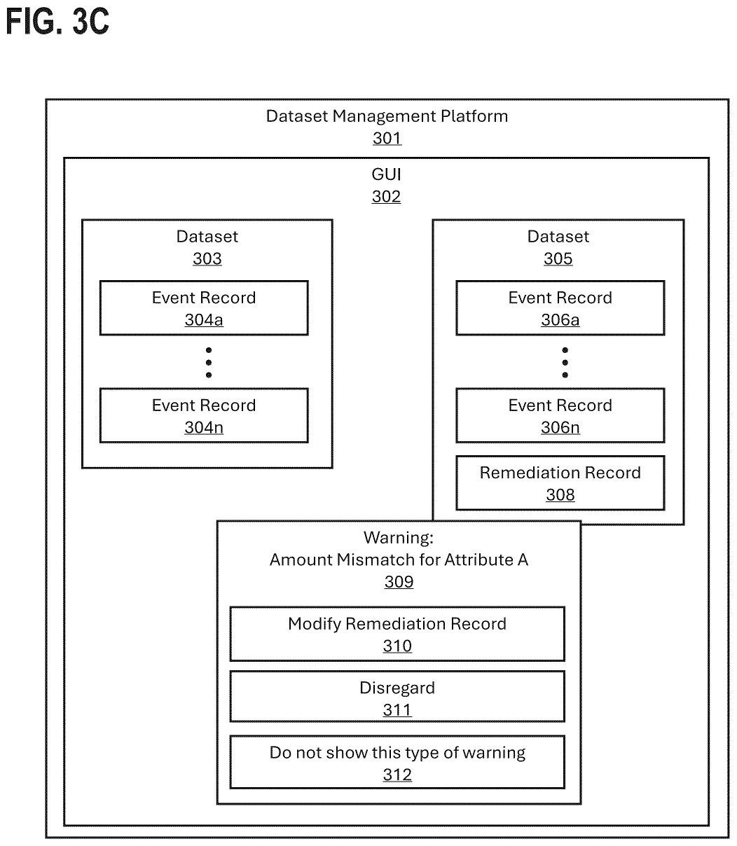

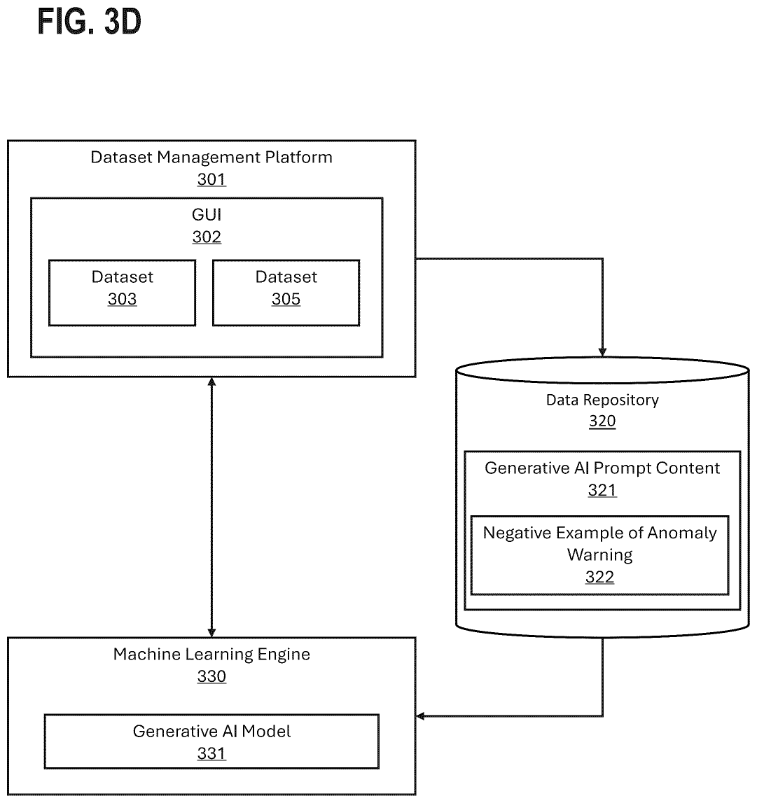

FIGS. 3A-3D illustrate operations for predicting and remediating anomalies based on remediation records used to reconcile datasets. Referring to FIG. 3A, a dataset management platform 301 presents datasets 303 and 305 in a GUI 302. For example, a user may interact with the GUI 302 to select the dataset 305 to present a set of event records 306a-306n. The user may select an interface icon to select the dataset 303 to reconcile to the dataset 305. The GUI 302 may display a set of event records 304a-304n included in the dataset 303. In the example in FIG. 3A, the GUI 302 presents an interface element 307 to “reconcile”the datasets 303 and 305. Selecting the “reconcile” interface element 307 may result in either the dataset management platform 301 automatically performing a reconciliation, without human intervention, or in a human entering data in a remediation record for remediating a discrepancy between the datasets 303 and 305.

As illustrated in FIG. 3B, selecting the “reconcile” interface element 307 of FIG. 3A results in the generation of a remediation record 308 to be added to the dataset 305. For example, a user may enter attribute values and a category into a set of fields presented in the GUI 302 to generate the remediation record 308. In an example, the GUI 302 displays a cumulative “amount” value for an attribute in the dataset 303 and the dataset 305. A user may determine that a discrepancy exists between the cumulative amount value for the attribute of the dataset 303 and the attribute of the dataset 305. The user may enter an amount for the attribute in the remediation record 308 to reconcile the cumulative amounts for the attribute in the datasets 303 and 305.

As illustrated in FIGS. 3C and 3D, based on detecting the generation of the remediation record 308, the dataset management platform 301 generates a prompt to provide to a generative AI machine learning model 331. The prompt includes attribute data for the remediation record 308. The prompt further includes attributes of the datasets 303 and 305. Based on the prompt, the generative AI model 331 generates a text-based message 309. The message is a warning that a mismatch appears to exist for an attribute “Attribute A” between the datasets 303 and 305. The message appears in a window 309 in the GUI. The window 309 includes a set of selectable interface elements 310-312. Interface element 310 corresponds to a selection to modify the remediation record 308. Interface element 311 corresponds to a selection to disregard the warning. Selecting the interface element 311 may cause the GUI 302 to hide the warning window 309. Interface element 312 corresponds to an instruction to hide the type of warning in future reconciliations.

In the example embodiment in FIGS. 3C and 3D, the user selects interface element 312. The dataset management platform 301 generates prompt content 321 to include in subsequent prompts to the generative AI model 331. The prompt content 321 generated based on selection of the interface element 312 includes instructions to not generate warnings of the type presented in window 309. In other words, the prompt includes content associated with the anomaly warning as a negative example 322. As an example, event records 304a-304n and 306a-306n and remediation record 308 may include an Attribute A, an Attribute B, and an Attribute C. A user may generate the remediation record to reconcile values for Attribute C between the datasets 303 and 305. Accordingly, the user may select the interface element 312 to cause the generative AI model 331 to refrain from generating a warning associated with Attribute A.

When the dataset management platform 301 detects a subsequent remediation record being generated, the dataset management platform 301 generates a prompt that includes the warning associated with Attribute A as a negative example 322. As a result, the generative AI model 331 does not generate an anomaly warning associated with Attribute A even if the generative AI model 331 determines that a discrepancy exists associated with Attribute A.

According to another example embodiment, the machine learning engine 330 may retrain a fine-tuning head of the generative AI model 331 based on a dataset that includes generative AI prompt content 321. Accordingly, the system may improve the performance of the generative AI model 331 over time based on user feedback to generated anomaly prediction messages.

According to one example embodiment, the dataset 305 represents a set of software updates (described in event records 306a-306n) broadcast from a central server to client servers. The dataset 303 represents a set of software updates (described in event records 304a-304n) received by a client server. Referring to FIG. 3A, selecting the “reconcile” interface element 307 causes the system to identify any discrepancies between updates broadcast by the central server and updates received by the client server. Referring to FIG. 3B, the system identifies an update that was broadcast by the central server but was not received by the client server. For example, the central server may include a broadcast record describing “Update Version No. 5.112” and a data file size of “10 Gb.”The system generates a remediation record 308 in the dataset 305, indicating that the update was not received by the client server. The remediation record 308 may identify the update and the client server. For example, the remediation record may include the following:
Date of Entry: 1/31/22
Category: Update not received by client
Data Size: 10 Gb
Update type: Version 5.112
Date of Broadcast: 1/5/22

The remediation record 308 may further cause the system to perform one or more operations, such as re-sending the update to the client server or storing a notification in an update record to reflect the actual state of the dataset 303.

Referring to FIG. 3C, the generative AI model may detect an anomaly associated with the remediation record 308. The “amount mismatch” may correspond to a version number associated with the dataset 303 and the remediation record 308.

For example, the generative AI model may generate the warning message in window 309 based on determining that the version number of the update associated with the remediation record 308 “5.112” is lower than the version number of the most recent update “Version 5.114” corresponding to event record 304n in dataset 303. In one example, a user may determine that the update associated with the remediation record 308 is not required in the client server. The user may select the “modify remediation record” interface element 310 to delete the remediation record 308. In another example, a user may determine that the update associated with the remediation record 308 is required, and the difference in version numbers may result in incompatibilities. The user may select the “modify remediation record” interface element 310 to change the version number of the remediation record 308 to a value compatible with the datasets 303 and 305.

For example, if a version number of the event records 304n and 306n is “5.114,” the user may set the version number of the remediation record 308 to “5.114.1” instead of “5.112” to allow the system to recognize the update as needing to be sent to the client server subsequent to the most recently-broadcast update “Version 5.114”.

According to yet another example, the user may determine that the warning does not apply to software update application. The user may select the interface element 312 to direct the generative AI model to not show the warning associated with version numbers that are out of order. Referring to FIG. 3D, the dataset management platform 301 generates prompt content 321, including the warning as a negative example 322 to direct the generative AI model 331 to refrain from presenting the warning associated with out-of-sequence version numbers in the future.

According to another example embodiment, the dataset 305 represents an inventory record of goods transferred from a central warehouse to storage facilities and retail facilities. The dataset 303 represents goods received by a remote warehouse from the central warehouse as well as goods sent from the remote warehouse to other facilities. Referring to FIG. 3A, selecting the “reconcile” interface element 307 causes the system to identify any discrepancies between goods transferred from the central warehouse to the remote warehouse. Referring to FIG. 3B, the system identifies a shipment that was sent by the central warehouse that was not received by the remote warehouse. The system generates a remediation record 308 in the dataset 305 indicating that the shipment was not received by the remote warehouse. The remediation record 308 may identify the number and type of goods in the shipment and the remote warehouse receiving the shipment. The remediation record 308 may further cause the system to perform one or more operations such as querying a shipment management system to determine a delivery status of the shipment. Referring to FIG. 3C, the generative AI model may detect an anomaly associated with the remediation record 308. The “amount mismatch” may correspond to a number of goods listed in the remediation record 308.

For example, the generative AI model may generate the warning message in window 309 based on determining that the number of goods listed in the remediation record 308 is lower than the number of goods included in the shipment (which may be represented by an event record 306n). In one example, a user may determine that the value included in the remediation record 308 was entered in error. The user may select the “modify remediation record” interface element 310 to change the value in the remediation record 308. In another example, a user may determine that the value entered in the event record 306n associated with the shipment was in error. The user may select the “modify remediation record” interface element 310 to generate a second remediation record to record the error in the event record 306n. According to yet another example, the user may determine that the warning does not apply. The user may select the interface element 312 to direct the generative AI model to not show the warning associated with discrepancies among a number of goods in a shipment that are less than a threshold (such as a discrepancy of 10 goods in a shipment of 10,000 goods). Referring to FIG. 3D, the dataset management platform 301 generates prompt content 321, including the warning as a negative example 322 to direct the generative AI model 331 to refrain from presenting the warning associated with insignificant discrepancies of numbers of goods or discrepancies that are less than a threshold value.

### 5. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes.

Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 6. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

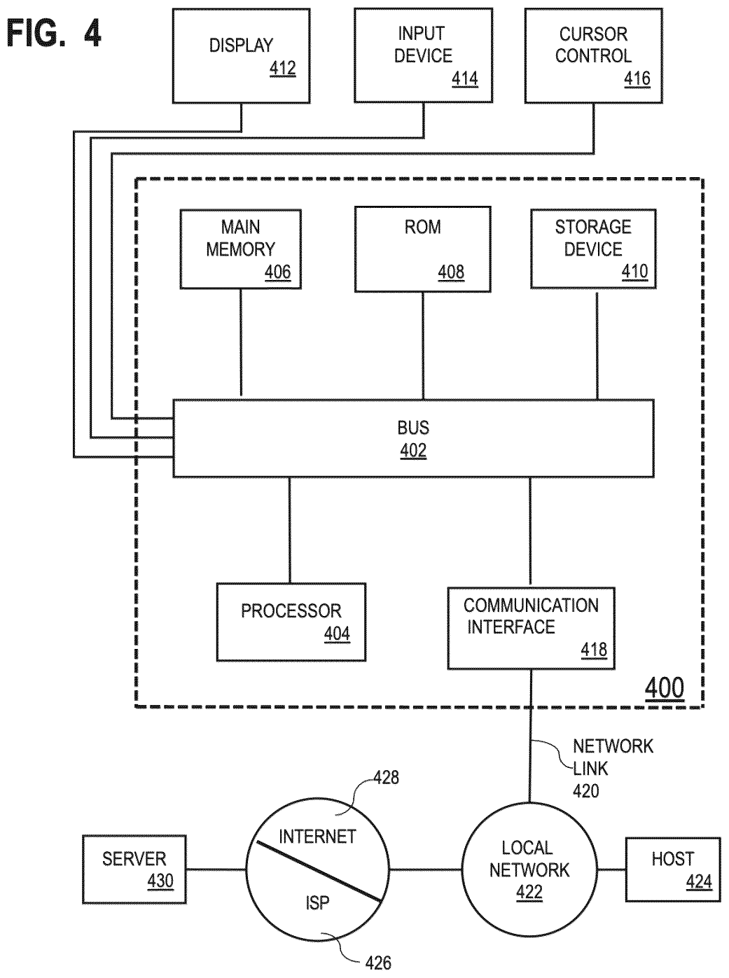

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 7. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
presenting, in a graphical user interface (GUI) a first set of event records and a second set of event records;
detecting generation of a first remediation record in the second set of event records to reconcile a first discrepancy associated with the first set of event records and the second set of event records;
in response to the generation of the first remediation record, evaluating, in real-time, the first remediation record at least by:
generating a set of prompt content comprising:
the first remediation record; and
contextual data associated with at least one of the first set of event records and the second set of event records; and
providing the prompt content to a generative artificial intelligence (AI) model trained to detect anomalies in remediation records;
obtaining, from the generative AI model, a first output identifying a first anomaly associated with the first remediation record;
remediating the first anomaly associated with the first remediation record to generate a second remediation record; and
modifying the second set of event records to include the second remediation record.

2. The one or more non-transitory computer readable media of claim 1, wherein modifying the second set of event records to include the second remediation record includes replacing the first remediation record with the second remediation record.

3. The one or more non-transitory computer readable media of claim 1, wherein the operations further comprise:
training the generative AI model to detect remediation record anomalies at least by:
generating a training data set comprising (a) historical datasets, (b) historical discrepancies associated with pairs of the historical datasets, (c) historical remediation records added to the historical datasets to remediate the historical discrepancies; (d) historical anomalies associated with the historical remediation records; and
training the generative AI model based on the training data set.

4. The non-transitory computer readable media of claim 3, wherein the operations further comprise:
training the generative AI model to detect remediation record anomalies at least by:
obtaining a pre-trained transformer-type machine learning model;
generating a neural network layer to receive an output from the pre-trained transformer-type machine learning model;
obtaining the training data set; and
applying the training data set to a machine learning algorithm to determine first parameters for the generative AI model at least by:
freezing second parameters of the pre-trained transformer-type machine learning model while modifying third parameters of the neural network layer based on an error function.

5. The one or more non-transitory computer readable media of claim 1, wherein remediating the
first anomaly in the first remediation record comprises presenting, in the GUI, a recommendation to modify the first remediation record to remediate the first anomaly, wherein the operations further comprise:
based on the recommendation, detecting a user selection to modify the first remediation record to remediate the first anomaly;
based on the user selection, generating a training record;
modifying a training dataset to include the training record to generate a modified training data set; and
retraining the generative AI model with the modified training data set.

6. The one or more non-transitory computer readable media of claim 1, wherein the operations further comprise:
presenting, in the GUI, a recommendation to modify a third remediation record to remediate a second anomaly;
detecting a user selection to refrain from modifying the third remediation record in a manner recommended in the recommendation;
based on the user selection, generating a training record;
modifying a training dataset to include the training record to generate a modified training data set; and
retraining the generative AI model with the modified training data set.

7. The one or more non-transitory computer readable media of claim 1, wherein the operations further comprise:
presenting, in the GUI, a recommendation to modify a third remediation record to remediate a second anomaly identified by the generative AI model;
detecting a user selection to refrain from modifying the third remediation record in a manner recommended in the recommendation;
based on the user selection, generating a second set of prompt content including the recommendation as a negative example;
providing the second set of prompt content to the generative AI model; and
responsive to providing the second set of prompt content to the generative AI model, obtaining from the generative AI model a second output that does not identify the second anomaly in the third remediation record.

8. The one or more non-transitory computer readable media of claim 1, wherein remediating the first anomaly in the first remediation record comprises presenting, in the GUI, a recommendation to modify the first remediation record to remediate the first anomaly, wherein the operations further comprise:
based on the recommendation, detecting a user selection to modify the first remediation record to remediate the first anomaly;
detecting, in the user selection, an indicator that the user selection is an exception; and
based on detecting the indicator that the user selection is an exception, refraining from generating a training record corresponding to the user selection for retraining the generative AI model.

9. The one or more non-transitory computer readable media of claim 1, wherein the operations further comprise:
generating, by the generative AI, a recommendation to remediate the first anomaly,
wherein the recommendation includes the second remediation record,
wherein remediating the first anomaly in the first remediation record to generate a second remediation record comprises:
detecting, based on a user interaction with the GUI, a selection to (a) generate the second remediation record and (b) include the second remediation record in the second set of event records.

10. The one or more non-transitory computer readable media of claim 1, wherein reconciling the first discrepancy improves consistency associated with the first set of event records and the second set of event records.

11. The one or more non-transitory computer readable media of claim 1, wherein the operations
further comprise:
receiving a request to access a target set of records corresponding to a target set of events recorded in the second set of event records; and
responsive to receiving the request to access the target set of records corresponding to the target set of events: returning a modified second set of event records that includes the second remediation record instead of returning the second set of event records.

12. A method comprising:
presenting, in a graphical user interface (GUI) a first set of event records and a second set of event records;
detecting generation of a first remediation record in the second set of event records to reconcile a first discrepancy associated with the first set of event records and the second set of event records;
in response to the generation of the first remediation record, evaluating, in real-time, the first remediation record at least by:
generating a set of prompt content comprising:
the first remediation record; and
contextual data associated with at least one of the first set of event records and the second set of event records; and
providing the prompt content to a generative artificial intelligence (AI) model trained to detect anomalies in remediation records;
obtaining, from the generative AI model, a first output identifying a first anomaly associated with the first remediation record;
remediating the first anomaly associated with the first remediation record to generate a second remediation record; and
modifying the second set of event records to include the second remediation record,
wherein the method is performed by at least one device including a hardware processor.

13. The method of claim 12, wherein modifying the second set of event records to include the second remediation record includes replacing the first remediation record with the second remediation record.

14. The method of claim 13, further comprising:
training the generative AI model to detect remediation record anomalies at least by:
generating a training data set comprising (a) historical datasets, (b) historical discrepancies associated with pairs of the historical datasets, (c) historical remediation records added to the historical datasets to remediate the historical discrepancies; (d) historical anomalies associated with the historical remediation records; and
training the generative AI model based on the training data set.

15. The method of claim 14, further comprising:
training the generative AI model to detect remediation record anomalies at least by:
obtaining a pre-trained transformer-type machine learning model;
generating a neural network layer to receive an output from the pre-trained transformer-type machine learning model;
obtaining the training data set; and
applying the training data set to a machine learning algorithm to determine first parameters for the generative AI model at least by:
freezing second parameters of the pre-trained transformer-type machine learning model while modifying third parameters of the neural network layer based on an error function.

16. The method of claim 12, wherein remediating the first anomaly in the first remediation record comprises presenting, in the GUI, a recommendation to modify the first remediation record to remediate the first anomaly, wherein the method further comprises:
based on the recommendation, detecting a user selection to modify the first remediation record to remediate the first anomaly;
based on the user selection, generating a training record;
modifying a training dataset to include the training record to generate a modified training data set; and
retraining the generative AI model with the modified training data set.

17. The method of claim 12, further comprising:
presenting, in the GUI, a recommendation to modify a third remediation record to remediate a second anomaly;
detecting a user selection to refrain from modifying the third remediation record in a manner recommended in the recommendation;
based on the user selection, generating a training record;
modifying a training dataset to include the training record to generate a modified training data set; and
retraining the generative AI model with the modified training data set.

18. The method of claim 12, further comprising:
presenting, in the GUI, a recommendation to modify a third remediation record to remediate a second anomaly identified by the generative AI model;
detecting a user selection to refrain from modifying the third remediation record in a manner recommended in the recommendation;
based on the user selection, generating a second set of prompt content including the recommendation as a negative example;
providing the second set of prompt content to the generative AI model; and
responsive to providing the second set of prompt content to the generative AI model, obtaining from the generative AI model a second output that does not identify the second anomaly in the third remediation record.

19. The method of claim 12, further comprising:
wherein remediating the first anomaly in the first remediation record comprises presenting, in the GUI, a recommendation to modify the first remediation record to remediate the first anomaly,
wherein the method further comprises:
based on the recommendation, detecting a user selection to modify the first remediation record to remediate the first anomaly;
detecting, in the user selection, an indicator that the user selection is an exception; and
based on detecting the indicator that the user selection is an exception, refraining from generating a training record corresponding to the user selection for retraining the generative AI model.

20. A system comprising:
at least one device including a hardware processor;
the system being configured to perform operations comprising:
presenting, in a graphical user interface (GUI) a first set of event records and a second set of event records;
detecting generation of a first remediation record in the second set of event records to reconcile a first discrepancy associated with the first set of event records and the second set of event records;
in response to the generation of the first remediation record, evaluating, in real-time, the first remediation record at least by:
generating a set of prompt content comprising:
the first remediation record; and
contextual data associated with at least one of the first set of event records and the second set of event records; and
providing the prompt content to a generative artificial intelligence (AI) model trained to detect anomalies in remediation records;
obtaining, from the generative AI model, a first output identifying a first anomaly associated with the first remediation record;
remediating the first anomaly associated with the first remediation record to generate a second remediation record; and
modifying the second set of event records to include the second remediation record.
